(19) United States
(12) Patent Application Publication
(10) Pub. No.: US 2008/0218773 A1
(43) Pub. Date: Sep. 11, 2008

(54) Image scaling for an electrophotographic device to obtain various media output speeds

(75) Inventors: Kevin D. Schoedinger, Lexington, KY (US); David J. Mickan, Lexington, KY (US); David K. Lane, Lexington, KY (US); Eric W. Westerfield, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/713,874

(22) Filed: Mar. 5, 2007

(51) Int. Cl. G06F 15/00

(52) U.S. Cl. 358/1.2

(57) ABSTRACT

Methods and apparatus include scaling imaging of an electrophotographic (EP) device, such as a laser printer or copy machine, to obtain various media output speeds (in pages per minute). A scanning unit has a substantially fixed scan rate during printing and reflects a laser beam onto a photoconductor to create a latent image at a first resolution. A media is advanced into contact with the latent image at a predetermined printing process speed to obtain a printed image output of the latent image at a size corresponding to a size (job resolution) of the image input data, but at a resolution different than the resolution of the image data input. A controller alters data used to create the latent image. Techniques for altering resolution include processing relative to a raster image processor to stretch one resolution dimension of the bitmap into a larger resolution dimension.

### FIELD OF THE INVENTION

Generally, the present invention relates to electrophotographic (EP) devices, such as laser printers or copy machines. Particularly, it relates to adjusting print speed of the EP device by scaling imaging data. In one aspect, bitmap resolution is stretched, such as by insertion of lines of bitmap data or by other processing. An EP device incorporating the image scaling has a fixed scan rate and utilizes either bi-directional scanning or traditional unidirectional scanning.

### BACKGROUND OF THE INVENTION

Traditional EP devices have a spinning polygon mirror that directs a laser beam to a photoconductor, such as a drum, to create one or more scan lines of a latent to-be-printed image. Recently, however, it has been suggested that torsion oscillator or resonant galvanometer structures can replace the traditional spinning polygon mirror and create scan lines in both the forward and reverse directions (e.g., bi-directionally), thereby increasing efficiency of the EP device. Because of their MEMS scale size and fabrication techniques, the structures reduce the relative cost of manufacturing. Unfortunately, the structures are tuned to a fixed, resonant frequency of oscillation, unlike their polygon mirror counterparts, which tends to limit printing at media output speeds of full speed or half speed modes, only (e.g., 50 pages per minute (ppm) or 25 ppm). In that robust, modern EP devices require all sorts of media output speeds, especially per different media types, e.g., transparencies, vinyl labels, envelopes, etc., two speeds is quite insufficient.

Accordingly, a need exists in the art to enable a variety of media output speeds, despite fixation of the rate of scanning of latent images brought about by the advent of oscillator or galvanometer type scanning mechanisms. Ultimately, the need extends to any scanning mechanism, regardless of type, having a relatively fixed scan rate. Naturally, any improvements along such lines should further contemplate good engineering practices, such as relative inexpensiveness, stability, low complexity, ease of implementation, etc.

### SUMMARY OF THE INVENTION

The above-mentioned and other problems become solved by applying the principles and teachings associated with the hereinafter described image scaling for an electrophotographic (EP) device, such as a laser printer or copy machine, to obtain various media output speeds, especially in pages per minute (ppm).

In a basic sense, an EP device with a substantially fixed scan rate scans multiple scan lines on a photoconductor to create a latent image at a first resolution, as is typical. A media is advanced into contact with the latent image at a predetermined process speed to obtain a printed image output of the latent image. Beforehand, however, a controller alters image input data used to create the latent image by changing a bitmap at a second resolution into a bitmap at the first resolution. Certain techniques for altering the resolution include conducting pre- and/or post-processing regarding a raster image processor (RIP). In one embodiment, the resolution dimension of an input bitmap is stretched into a larger resolution dimension, such as that which occurs by stretching a 600×600 resolution into a 600×685 resolution or other. Repeating scan lines and inserting them into the bitmap is one such technique to stretch the bitmap as is visual processing whereby scan lines are created and inserted to make the hard copy image appear correct.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative EP device;

FIGS. 2A and 2B are diagrammatic views in accordance with the present invention of desirable scan lines and reference positions in a uni-directionally and bi-directionally scanning EP device;

FIG. 3 is a diagrammatic view in accordance with the present invention of a more detailed version of a representative scanning mechanism of the EP device of FIG. 1;

FIGS. 4A-4D are diagrammatic views in accordance with the present invention of representative image input data and printed image outputs;

FIGS. 5A and 5B are diagrammatic views in accordance with the present invention of representative processing arrangements to alter images; and

FIGS. 6A-6C are diagrammatic views in accordance with the present invention of representative bitmaps to obtain various media output speeds according to the EP device of FIG. 1.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, software, and/or other changes may be made without departing from the scope of the present invention. In accordance with the present invention, image scaling for an electrophotographic (EP) device, such as a laser printer or copy machine, to obtain various media output speeds is hereafter described.

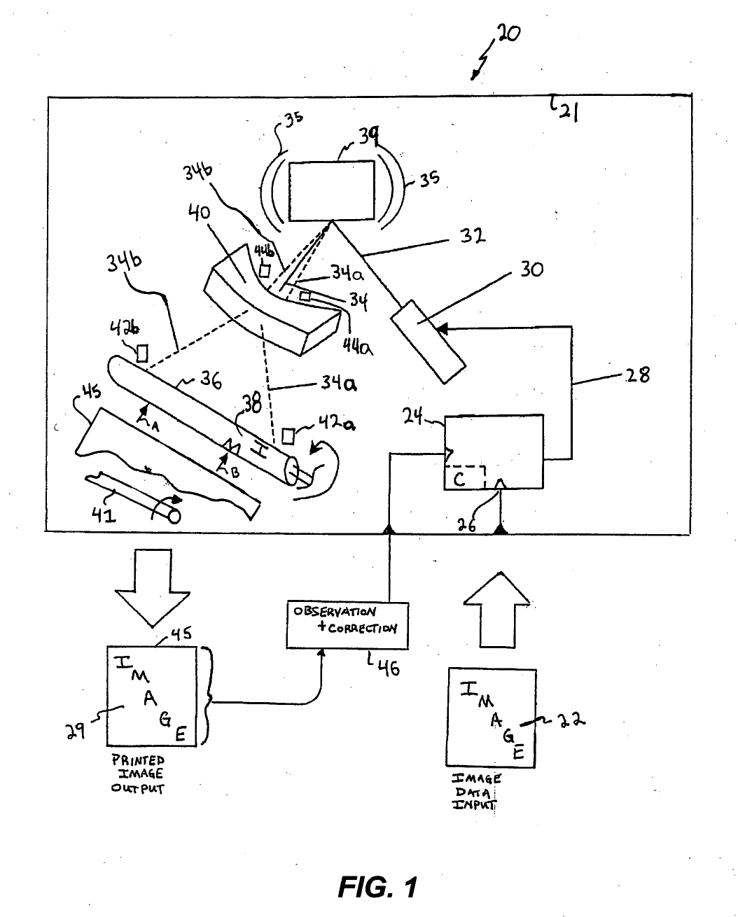

With reference to FIG. 1, an EP device 20 of the invention representatively includes mono or color laser printers or copier machines in a housing 21. During use, image data 22 is supplied to the EP device from somewhere external, such as from an attendant computer, phone, camera, scanner, PDA, laptop, or like computing device. A controller 24 receives the image data at an input 26 and configures an appropriate output, video signal 28 to produce a latent image of the image data. In turn, a hard-copy printed image 29 of the image data is obtained from the latent image. If print alignment and operating conditions of the EP device are well calibrated, the printed image 29 corresponds nearly exactly with the image data input 22. If not, the printed image has poor quality.

With more specificity, the output, video signal 28 energizes a laser 30 to produce a beam 32 directed at a scanning unit 39, such as a torsion oscillator, e.g., resonant galvanometer, or spinning polygon mirror. As the scanning unit moves (indicated by the movement or oscillation wave lines 35) the beam 32 is reflectively cast to create beam lines 34a, 34b on either side of a central position 34. As a result, multiple scan lines in alternate directions (or similar directions for the mirror embodiment) are formed on a photoconductor 36, such as a drum, and together represent a latent image 38 of the image data supplied from the controller.

Optically, certain lenses, mirrors or other structures 40 exist between the photoconductor and the scanning unit and transform the laser beam into a substantially linear scan of a beam at the photoconductor 36, including a substantially uniform linear scan velocity with substantially uniform laser beam spot size along the imaging area of the drum. To provide common reference for the beam lines, various sensors are employed. Preferably, a forward sensor 42a and a reverse sensor 42b, called horizontal synchronization (hsync) sensors, are positioned near opposite ends of the photoconductor to provide a common reference for all forward scanning beam lines and all reverse scanning beam lines, respectively. In addition to, or in lieu of the sensors 42a, 42b, forward and reverse hsync sensors may be positioned at 44a and 44b, upstream of the representative optics 40. Alternatively still, a single hsync sensor might be used with one or more mirrors emplaced variously to act as a second hsync sensor. Regardless, the outputs of these sensors are supplied to the controller 24 for referencing correct locations of the scan line(s) of the latent images.

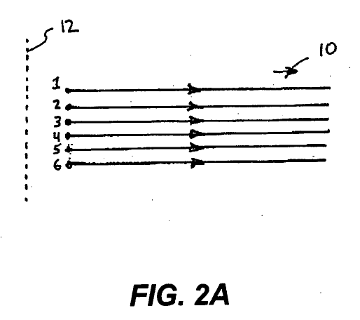

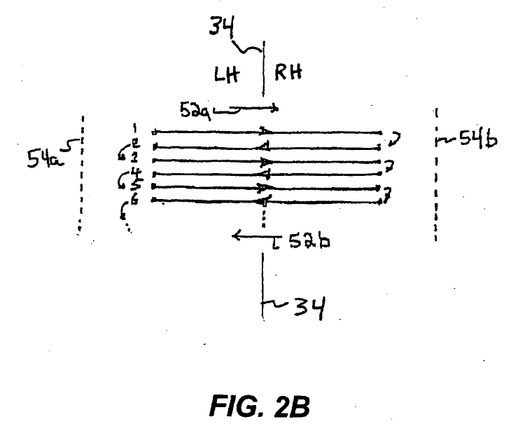

With reference to FIGS. 2A and 2B, conceptual, desired scan lines on a photoconductor, and respective reference positions for uni-directionally or bi-directionally scanning EP devices, are shown. That is, multiple scan lines (1-6) are shown and all extend in the direction of the arrows left-to-right in a uni-directional scanning embodiment 10, FIG. 2A, or, in odd numbered scan lines (1, 3, and 5) in a forward scan direction 52a opposite that in even numbered scan lines (2, 4, and 6) extending in a reverse scan direction 52b, FIG. 2B. Also, the forward and reverse scan lines alternate with one another in FIG. 2B and such is the nature of scanning with the torsion oscillator or resonant galvanometer embodiment. In either, common referencing occurs relative to a single laser beam sensor position 12 or relative to multiple reference positions 54a, 54b per each of the forward scanning or backward scanning lines, respectively.

Regardless of type, the printed image in FIG. 1 is ultimately formed from the latent image by applying toner at a developing station and directly or indirectly (by way of an intermediate transfer mechanism, such as a belt) transferring the image to a media 45, such as a sheet of paper. As the media advances through the EP device 20 in a process direction, arrows A and B, it occurs at a process speed by way of an advancer, such as a belt, roller 41, etc., as is typical. Eventually, the media 45 with the printed image 29 exits the EP device where users handle it for a variety of reasons.

As before, however, the printed image 29 is not always an accurate representation of the image data input 22 and various operations are employed to tightly calibrate the EP device. In this regard, a variety of sensors for temperature, pressure, etc. are used to learn ambient operating conditions and/or an observation and correction feedback loop 46, of sorts, is employed to fix image nuances. In one instance, this corresponds to an end-user making a visual observation of the printed image and informing the EP device, such as by way of a user interface of an attendant computer (not shown) or an operator panel directly on the EP device, of a preferred correction. In another, a reading of the printed image occurs and an automated selection is made and conveyed to the EP device. Reading, as is well known, can occur by way of optical scanners or other devices. In still another instance, the observation and correction occurs internal to the EP device such as by observing a printed image still in the EP device or by observing the latent image 38 on the photoconductor. Observation and correction can also occur relative to a specially made calibration page that manufacturers, service technicians or end-user operators employ as part of a manufacturing, servicing or end-user act for aligning print. Corrections C then occur by way of the controller 24 and its attendant output signal 28.

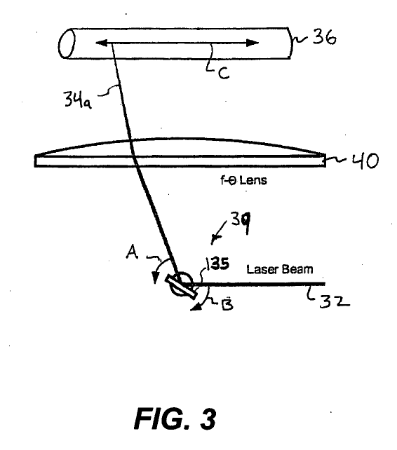

In that polygon mirrors are better known in the art as a scanning unit 39, reference to FIG. 3 is taken to show a slightly more detailed version of the scanning unit 39 embodied as an oscillator, such as a galvanometer. In this regard, the scanning mechanism includes a reflective surface 135, such as a mirror, that is caused to rotate about a central pivot point in either a first direction given by arrow A or in an opposite direction given by arrow B. The laser beam 32 upon hitting the reflective surface is then caused to impinge upon the photoconductor 36 to make scan lines of a latent image in opposite directions given by bi-directional arrow C. Also, drive means (not shown) exert a torque on the scanning mechanism to push it, so to speak, to rotate (in either the direction of arrow A or B). In this regard, the torque occurs for a relatively short period of time, but adds a sufficient amount of energy to the system of the scanning mechanism so that correct scan amplitude is maintained for at least both a right half of a forward scan and a right half of a scan in the reverse. Thereafter, upon the scanning mechanism reaching a corresponding mid-point or centerline of its scan line, the scanning mechanism is similarly pushed (now in the opposite direction of either arrow A or B) to complete the left half of the reverse scan line, followed by the left half of the forward scan line. Over time, the process repeats and multiple scan lines are produced. By analogy, the scanning mechanism is akin to a pendulum that gets pushed in both a forward and reverse direction. By operation of gravity and other forces, the pendulum reverses direction on its own as it transitions from the forward to the reverse directions at the apex. To keep the pendulum swinging with desired amplitude, pushes are occasionally given. Diagrammatically, the halves of the scan lines are seen in FIG. 2B according to the right half RH and left half LH appearing on opposite sides of a central position 34. It is also the case that the highest drive efficiency is achieved when the frequency of the push of the scanning mechanism (or pendulum, by analogy) coincides with the resonant frequency of the scanning mechanism, which essentially fixes the scanning rate of the EP device. In turn, limited media output speeds are the result unless a corrective technique is used.

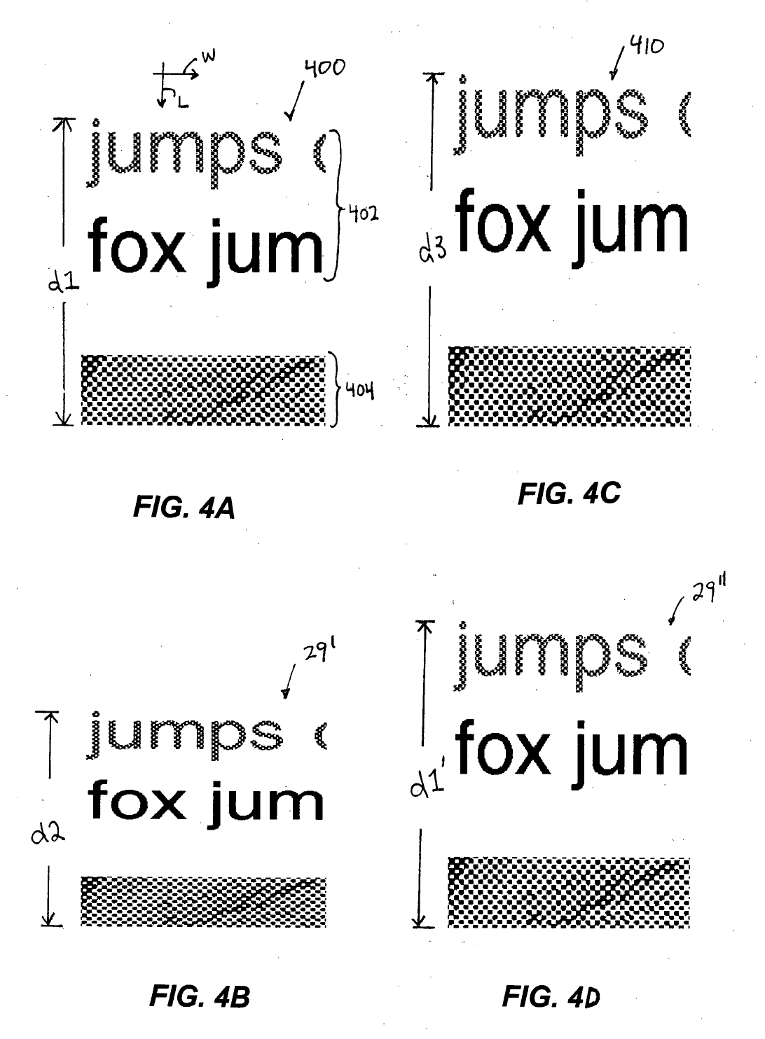

With reference to FIGS. 4A-4D, altering the image data input to the EP device to achieve various media output speeds is now described by way of example. That is, FIG. 4A shows a representative bitmap 400 for a to-be-printed image of an EP device and it consists of a variety of imagery, such as text 402 and symbols 404. In FIG. 4B, if the bitmap 400 were processed directly by the controller to create a latent image on a photoconductor and the process speed of the media was slowed, the resultant printed image output 29′ would be compressed. Stated differently, a slowed process speed for an otherwise original image input data would result in a distance d2 on a media less than the theoretical distance of d1 of the bitmap and printing quality would suffer. Also, an overall size (e.g., aspect ratio W×L) of the printed image output 29′ would be less than the size (e.g., aspect ratio) of the image data input.

However, by stretching the bitmap of the image input data into a bitmap 410, FIG. 4C, (e.g., enlarging the size, such as by enlarging d1 into d3) and then correspondingly slowing the process speed of printing, the resultant printed image output 29″ would be compressed relative to the bitmap theoretical size (e.g., distance d3, or aspect ratio), but would be the same as the size of the original input theoretical distance d1 of the bitmap 400 (e.g., d1′=d1). In other words, if the resolution of the bitmap 400 was 600 dots per inch (e.g., 600×600 (width, W, x length, L) and the resolution of the bitmap 410 was altered greater in one dimension, e.g., converting the 600×600 resolution into a 600×685 resolution, for example, the printed image output 29″ would have a size corresponding to the size of the image data input, (e.g., 600×600) as desired, but at a different resolution.

As should be appreciated by skilled artisans, this now enables various media output speeds. That is, having a fixed scan rate in a scanning unit, such as by tuning an oscillator or fixing a rotation speed of a polygon mirror, and only slowing down the printing process speed, the effective resolution is increased by a known scalar. If the print job is then processed to account for this scalar, i.e. creating an oversized bitmap vertically, then the resultant printed image output will be properly resized as the controller creates the latent image at the higher resolution. As has been shown in theory, and expected to be released soon in actual products by the assignee of this invention, an otherwise fixed scan rate oscillator in a laser printer operable at 600 or 1200 dpi only (full speed and half speed modes) will now be able to achieve the following operational points of media output speeds: 50 ppm to some maximum rated speed; 45 ppm to support legacy input option trays and output options that cannot go faster than 45 ppm; 40 ppm to support an envelop feeder option that cannot go faster than 40 ppm; and 35 ppm to support vinyl labels that cannot be fed and fused reliably at faster speeds. Also, typical scanning rates of oscillators fixed in EP devices that yield 35 ppm around 600 dpi operate per the following: 35 ppm*(1 l+1.8 in)/page*1 m/60 sec=7.467 in/sec*600 dpi=4,480 scans/sec. Now, such EP devices will yield more media output speeds than just full and half speed modes.

Intuitively, it should also be appreciated that the invention intermediately scales images so that the ultimate printed image output appears in size to the user exactly like the size of image input data. The import of this relates to prior art scaling techniques whereby hard-copy outputs appear different in size (and or shape) than the image input data, such as found with a single input image having two, three, four or more replicas of the single input on a single hard-copy. Also, the prior art has variable rate scanning devices at its disposal to accomplish this, unlike the present invention utilizing essentially fixed rate scanning units 39 (FIG. 1).

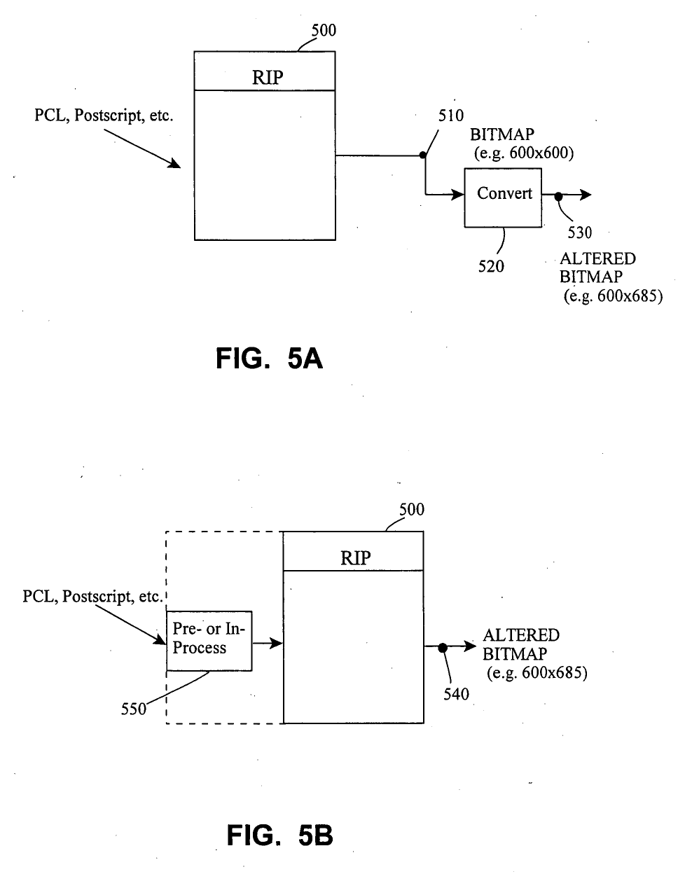

To actually achieve the foregoing-described altered bitmaps in a controller of an EP device, to obtain the desired various media output speeds, reference is taken to FIGS. 5A and 5B. In the former, a print job of image input data is received by a raster image processor (RIP) 500 in a variety of printing languages, PCL, Postscript, etc., as is typical. An output 510 of the RIP is then a bitmap having a size as is desired in dpi format of the final printed image output. However, a conversion 520 occurs in the controller to add or otherwise insert lines of bitmap data to the original bitmap so that its resolution enlarges or stretches in at least one dimension, such as by converting a 600×600 resolution into 600×685 resolution, to achieve an altered bitmap 530 (also, bitmap 410, FIG. 4C). Alternatively, the bitmap from the RIP 500 is directly processed to yield an altered bitmap 540 according to pre-processing or in-processing 550 done as in FIG. 5B. One implementation of this could involve the current transformation matrix (CTM) as described in section 4.3 of the Postscript Language Reference Manual (PLRM). Different emulators, such as PCL and PPDS could require unique scaling solutions. See, http://www.adobe.com/products/postscript/pdfs/PLRM.pdf, for example.

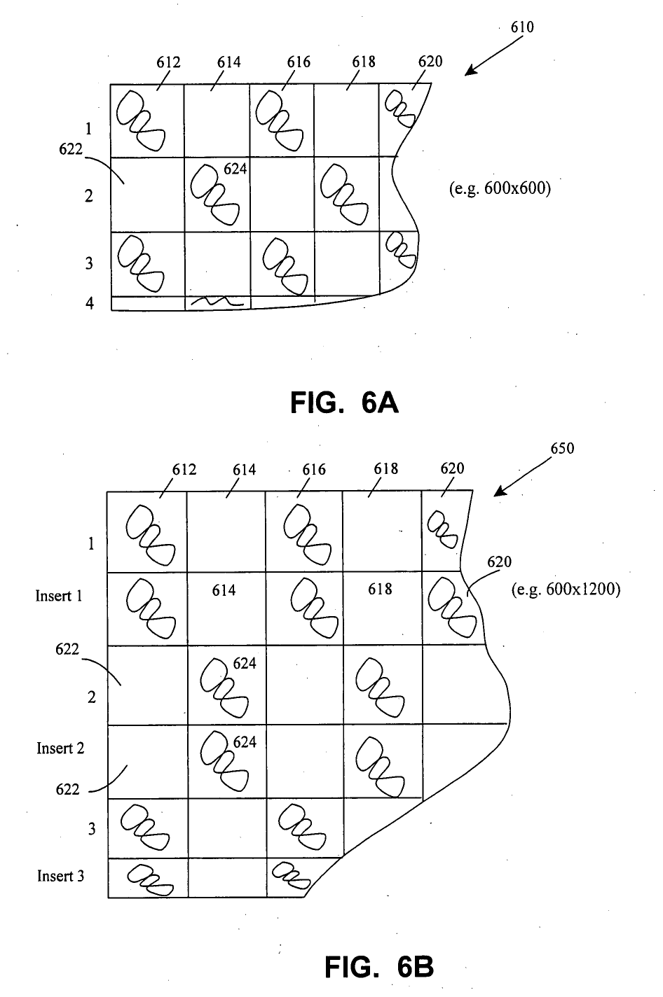

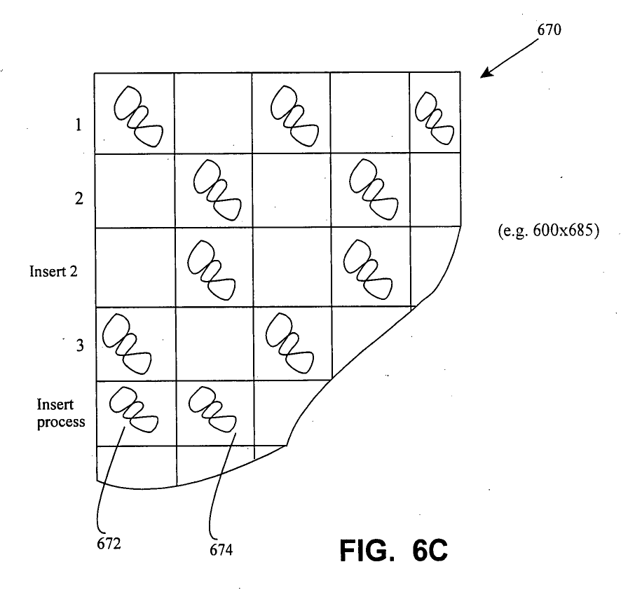

As an example of both, consider the bitmap 610 in FIG. 6A. In a variety of scan lines 1-4, bitmap data is provided per pixels 612, 614, 616, 618, 620, 622 to name a few, where the pixel is either on (to be scanned as part of the latent image, e.g., pixels 612, 616, 620, or 624) or off (to avoid being scanned as part of the latent image, e.g., pixels, 614, 618, or 622).

In FIG. 6B, an altered bitmap 650 is given having inserted scan lines insert 1, insert 2, and insert 3 (corresponding to FIG. 5A). In form, they consist of simply duplicated or repeated on/off scan line information corresponding to scan lines in the original bitmap data. That is, insert 1 is the same bitmap information as the scan line information of scan line 1 of bitmap 610, as is insert 2 being the same bitmap information as the scan line information of scan line 2 of bitmap 610, and so on. In this manner, a 600×600 resolution bitmap is stretched into a 600×1200 resolution bitmap, as seen. Then, upon scanning the latent image as bitmap 650, and slowing the printing process speed in the EP device, a printed image output can occur in a size corresponding to the size of the bitmap_at the original 600×600 resolution, but at a much lower ppm media speed output, such as 15 ppm. Of course, all resolution conversions of bitmaps are embraced herein and 600×600 into 600×1200 or 600×685 are only representative examples. Also, insertion of scan lines need not occur per every scan line of the original image input data.

Appreciating distortion or print artifacts may exist in the final printed image output if the original image input data is “overstretched,” it may be desirable to avoid or limit inserting redundant lines to stretch the bitmap resolution. In turn, FIG. 6C shows an embodiment of pre-processing or in-processing a print job, such as according to the arrangement of FIG. 5B, to avoid overstretching, or to provide an alternate embodiment of bitmap alteration. Namely, the original bitmap 610 is altered into a bitmap 670 having inserted lines, such as insert 2 and insert process, with pixels thereof either matching another line of the original bitmap 610 (e.g., insert 2 matches scan line 2) or simply being provided to make the ultimate hard-copy output appear without distortion or artifacts. In the latter, insert process has “on” pixels 672, 674 matching no other scan lines, for example, and is used to limit image distortion. Intuitively, however, there is no requirement to have both inserted scan lines matching a scan line of the original bitmap along with inserted process lines not matching. These are just representative embodiments and skilled artisans will be able to contemplate others. See, also, previously referenced section 4.3 of the PLRM. Alternatively still, skilled artisans will appreciate to-be-printed images of the invention are complex in form. In turn, the processing of such may include decomposition into a number of object types, including images, characters, rectangles, edge-lists, etc. Thus, scaling of images herein additionally contemplates the scaling of each object type, not just an entirety of the to-be-printed image.

Finally, one of ordinary skill in the art will recognize that additional embodiments of the invention are also possible without departing from the teachings herein. This detailed description, and particularly the specific details of the exemplary embodiments, is given primarily for clarity of understanding, and no unnecessary limitations are to be imported, for modifications will become obvious to those skilled in the art upon reading this disclosure and may be made without departing from the spirit or scope of the invention. Relatively apparent modifications, of course, include combining the various features of one or more figures with the features of one or more of other figures.

1. A method of scaling imaging for an electrophotographic device, comprising:
creating a latent image on a photoconductor having a first resolution;
developing the latent image into a printed image output having a size corresponding to a size of a bitmap of an image input data, the image input data having a second resolution different than the first resolution; and
altering the bitmap having the second resolution to a bitmap at the first resolution before the creating the latent image.

2. The method of claim 1, providing a scanning unit having a substantially fixed scan rate during printing, the scanning unit for reflecting a laser beam onto the photoconductor to create the latent image.

3. The method of claim 2, wherein the providing the scanning unit having the substantially fixed scan rate further includes providing one of a bi-directionally scanning oscillator and a spinning polygon mirror.

4. The method of claim 1, further including advancing a media into contact with the latent image at a predetermined printing process speed slow enough to obtain the printed image output at the size corresponding to the size of the bitmap of the image input data.

5. The method of claim 1, wherein the altering the bitmap further includes stretching one resolution dimension of the bitmap having the second resolution into a larger resolution dimension of the bitmap at the first resolution.

6. The method of claim 1, wherein the altering the bitmap further includes inserting scan line bitmap data into the bitmap having the second resolution to obtain the bitmap at the first resolution.

7. The method of claim 1, wherein the altering the bitmap further includes processing the bitmap having the second resolution before outputting the bitmap at the first resolution from a raster image processor.

8. The method of claim 1, further including receiving the bitmap from a computing device external to the electrophotographic device.

9. A method of scaling imaging of an electrophotographic device to obtain various media output speeds, comprising:
providing a scanning unit having a substantially fixed scan rate during printing, the scanning unit for reflecting a laser beam onto a photoconductor to create a latent image at a first resolution;
advancing a media into contact with the latent image at a process speed slow enough to obtain a printed image output of the latent image having an aspect ratio corresponding to an aspect ratio of a bitmap of an image input data, the image input data having a second resolution different than the first resolution; and
altering the bitmap of the image input data having the second resolution to a bitmap at the first resolution before or when the scanning unit reflects the laser beam onto the photoconductor.

10. The method of claim 9, wherein the providing the scanning unit having the substantially fixed scan rate further includes providing one of a bi-directionally scanning oscillator and a spinning polygon mirror.

11. The method of claim 9, wherein the altering the bitmap further includes stretching one resolution dimension of the bitmap having the second resolution into a larger resolution dimension of the bitmap at the first resolution.

12. The method of claim 9, wherein the altering the bitmap further includes inserting scan line bitmap data into the bitmap having the second resolution to obtain the bitmap at the first resolution.

13. The method of claim 9, wherein the altering the bitmap further includes processing the bitmap having the second resolution before or during raster image processing it into the bitmap at the first resolution.

14. The method of claim 9, further including receiving the bitmap having the second resolution from a computing device external to the electrophotographic device.

15. The method of claim 9, wherein the creating the latent image further includes scanning a plurality of scan lines in alternating directions on the photoconductor.

16. An electrophotographic device, comprising:
a scanning unit having a substantially fixed scan rate during printing of pluralities of print jobs of various latent images;
a photoconductor for being impinged with a plurality of scan lines formed in alternating or similar directions from a laser beam reflected by the scanning unit to create a latent image at a first resolution;
a media advancer to move a media into contact with the latent image at a process speed slow enough to obtain a printed image output of the latent image having an aspect ratio corresponding to an aspect ratio of a bitmap of an image input data, the image input data having a second resolution different than the first resolution; and
a controller for producing the latent image on the photoconductor, wherein the controller alters the bitmap having the second resolution to a bitmap at the first resolution.

17. The electrophotographic device of claim 16, wherein the scanning unit having the substantially fixed scan rate is a bi-directionally scanning oscillator or a rotatable polygon mirror.

18. The electrophotographic device of claim 16, wherein the controller further includes a raster image processor, the controller configured to alter the image input data upstream, downstream or in the raster image processor.

19. The electrophotographic device of claim 16, wherein the controller is configured to stretch one resolution dimension of the bitmap having the second resolution into a larger resolution dimension of the bitmap at the first resolution.

20. The electrophotographic device of claim 16, wherein the controller is configured to insert scan line bitmap data into the bitmap having the second resolution to obtain the bitmap at the first resolution.
